(19) United States
(12) Patent Application Publication
(10) Pub. No.: US 2005/0216292 A1
(43) Pub. Date: Sep. 29, 2005

(54) Method and system for financial evaluation of real estate properties

(76) Inventor: Jeffrey Michael Ashlock, San Jose, CA (US)

Correspondence Address: Patrick Reilly, Box 7218, Santa Cruz, CA, 95061-7218, US

(21) Appl. No.: 10/963,404

(22) Filed: Oct. 9, 2004

Related U.S. Application Data
(60) Provisional application No. 60/510,653, filed on Oct. 11, 2003.

(51) Int. Cl. G06F 17/60

(52) U.S. Cl. 705/1

(57) ABSTRACT

A system and method for evaluating the market or financial values of a subject real estate property is provided. In a first version of the method of the present invention, a data gatherer evaluates the subject property and a plurality of alternate properties, where all the properties are located within a specified geography, such as a zip code area or a township. The property evaluations of the data gatherer are then each matched with a proposed financial value of the related property, where the proposed financial value may be a sales price or an appraisal. The data gatherer provides the plurality of alternate property evaluations, each matched with a financial evaluation, along with an evaluation of the subject property to a data customer, such as an appraiser. The customer may then evaluate the market value of the subject property in light of a history of the data gatherer's subjective judgments.

### CROSS-REFERENCES TO RELATED APPLICATIONS

This application is a Continuation to Provisional Patent Application No. 60/510,653 filed on Oct. 11, 2003, and which is incorporated herein by reference in its entirety for all purposes.

### FIELD OF THE INVENTION

The present invention relates to the financial evaluation of real estate properties. More particularly, the present invention relates to integrating the subjective data generated by a particular data gatherer or a small plurality of individual data gatherers with the data management methods of customers or recipients of the generated data.

### BACKGROUND OF THE INVENTION

The prior art of financial valuation of real estate property typically relies upon the comparison between a subject property with a small set of comparable properties, where the comparable properties (“comps”) are located within an arbitrarily selected distance from the subject property, and relatively recent financial evaluations of each of the comps are available. In a very common prior art scenario, a home purchaser may be applying for a mortgage for the subject property. A potential lender will then require that a licensed appraiser compare the subject property with the set of comps. The set of comps may be selected from a group of properties that have sold within a time period of a year or less. The number of comps considered may vary, but is typically three and seldom includes more than four comparable properties. The appraiser will usually examine certain aspects and characteristics of the subject property and determine the comparable market or financial value of the subject property in light of the financial values and the aspects, characteristics and features of the comps. The appraiser may personally visit the subject property and/or one or more of the comps in order to determine the existence, nature and quality of one or more of the aspects, characteristics and features of the properties for use in making the comparison between the subject property and the comps. It is not untypical that the reputation and nature of the environs surrounding or associated with the subject property, and/or the reputation and nature of one or more of the comps, may be considered relevant and material by the appraiser in the comparison of the subject property with the comps. The appraiser may additionally or alternatively rely upon or consider information concerning the comps or the subject property by a third party or a third party agency, such as an automated valuation service, a multi-listing service, or governmental recording office, in assessing the financial or market value of the subject property. In effect, the appraiser using the prior art techniques of real estate property valuation may be relying upon valuations, judgments and data of irregular reliability and based upon the idiosyncratic findings of a variety of persons and sources.

The real estate valuation professionals are fundamentally concerned with the reliability and integrity of the data used to estimate the market values of real estate property. Numerous firms and agencies direct great expertise and expend significant energy in compiling and providing information regarding the nature and aspects of individual real estate properties, and in describing the environs and special conditions that may affect the financial valuation of real estate. Yet this economically vital area of professional financial analysis is awash in much information that is perishable and of indeterminate reliability. In addition, the promise of information technology systems to automate significant elements of the process of real estate valuation is fully dependent upon the quality of data available or potentially available in digital media or computer-readable media.

The prior art teaches that a large pool of individual data gatherers can be applied to build up a significantly dense database of descriptive commentary concerning a wide variety of real estate properties. The prior art fails to address the predictable and often consistent patterns of variation in the evaluation of many aspects of real estate evaluation that individual data gatherers exhibit. The typical prior art approach includes randomly assigning individual data gatherers to describe and evaluate a large pool of real estate properties. The prior art fails to anticipate the opportunity to rely upon the consistency of a single data gatherer, or a small group of data gatherers, to evaluate aspects of real estate property within a selected locale or geography.

There is, therefore, a long felt need to a method and a system that efficiently provides a user of real estate evaluation data with information about a subject property that has an improved degree of reliability.

### OBJECTS OF THE INVENTION

It is an object of the present invention to provide a method that enables the association of real estate data with other real estate data that has been at least partially influenced by a same data gatherer.

It is an additional optional object of the present invention to provide a method to massage observations of a subject property made by a particular data gatherer in light of a history of observations made by the same data gatherer of real estate properties located within a specified geography, whereby the informational output of the method is of improved reliability for use in automated financial valuations of real estate properties.

It is a further object of certain preferred embodiments of the present invention to enable a user of an information technology database to compare the subjective evaluations of an individual data gatherer throughout a plurality of database records of a plurality of properties.

It is another object of certain alternate preferred embodiments of the present invention to enable an appraiser of real estate property to compare an evaluation of a subject property reported by a data gatherer with a history of subjective evaluations of the data gatherer of a plurality of real estate properties located within a selected geography.

It is yet another object of certain still alternate preferred embodiments of the present invention to provide one or more categories of data associated with one or more records, where the records are stored within a database of aspects that relate to or describe a real estate property.

### SUMMARY OF THE INVENTION

These and other objects will be apparent in light of the prior art and this disclosure. The present invention provides a method and system for managing and accessing descriptive data generated by an individual data gatherer, or small group of data gatherers, concerning a subject real estate property. A small group of data gatherers is defined as used herein to include up to approximately six individual data gatherers.

In certain alternate preferred embodiments of the method of the present invention, substantially all of the real estate purchases that occur within a selected geography, such as a neighborhood or a township, are monitored by a selected data gatherer. The data gatherer creates a database of the properties that have been sold, wherein the same data gatherer's judgment is used in populating the database with information regarding or associated with substantially all of the purchased properties and/or the environs of the purchased properties. The database managed by the data gatherer may then be made available to third parties, such as real estate appraisers, for use by the third parties in comparing the features, qualities and characteristics of the purchased properties, now being used as comps, with the features, qualities and characteristics of a subject property. The third party may therefore more easily include a plurality of comps, rather than being limited to three or four comps, in the comparison process. The database may or may not include financial valuations or sales prices of the comps.

It is understood that the terms of appraisal, estimate and assessment as defined herein may each include the processes of generating, fixing, and selecting a financial value to associate with a comp, a real estate property, a subject property, or an aspect, quality, feature, or characteristic of a property or the environs of a property, for the purposes of financial valuation or tax assessment.

In certain still alternate preferred embodiments of the present invention, the data gatherer may accept third-party data from one or more other sources, such as another data gatherer, an automated valuation service, a governmental recording agency, and a multi-listing service, and the data gatherer may include the third-party data in the database. The data gatherer may optionally improve the quality of the database the third-party data by reviewing the third-party data and making judgments regarding the reliability and integrity of the third-party data and the source of the third-party data. This improvement of the quality of the database by modification to the data base by the data gatherer is referred to herein as “cleaning the database”. The database may provide an opportunity to a real estate appraiser to more thoroughly, or even exhaustively, consider information regarding a plurality or a multiplicity of comps, wherein the volume of information provided by the database to the appraiser may have taken an impracticable time commitment to gather or provide by prior art methods. The database may additionally be more accurate than data provided by a third-party or third-party agency, wherein the data gatherer has cleaned the data of the database and made consistent judgments concerning the data of the database. The database may also be provided to the appraiser on a prompt basis and at least partially by means of an information technology system.

A first preferred embodiment of the method of the present invention, or first method, provides a technique for evaluating the market value of a subject real estate property, wherein the subject real estate property (“subject property”) is located within a geography. The first method includes certain optional steps, to include:

a. creating a database of data related to a plurality of real estate properties, the data being substantially or entirely provided by third parties or sources other than data generated by the data gatherer;

b. collecting baseline records generated by the data gatherer, or a small number of identified individual data gatherers, of a plurality of alternate real estate properties located within the geography;

c. forming a plurality of data combinations of a property identification data and a financial value data (“ID/value couple”), or at least one comparison ID/value couple, by associating a market value of at least one evaluated alternate real estate property with at least one of the baseline records, where a financial valuation of each alternate property, such as a sales price and/or another suitable financial metric known in the art is paired with a baseline record, each baseline record including a description of the relevant property;

d. receipt of an observed evaluation of the subject property by a user of the data from the data gatherer, or one of the plurality of identified data gatherers; and

e. assessing, appraising or estimating the market value of the subject property by comparison of the observed evaluation of the subject property with the plurality of ID/value couples, or at least one comparison ID/value couple, whereby the judgement of the same data gatherer, or the small group of data gathers, at least partially determines the informational content of at least one comparison ID/value couple and the observed evaluation of the subject property.

The financial or market valuation of the subject property, and one or more comparison ID/value couples, may be provided to a user of data, such as a government agency, a mortgage company or another suitable financial services venture known in the art, to include an automated valuation service. The financial valuation associated with an alternate real estate property may optionally be provided by or sourced from an automated real estate valuation system. In addition, the first technique, and certain alternate preferred embodiments of the method of the present invention, may be optionally directed to limit the comparison data considered within the method to ID/value couples having an associated market value determined no later than approximately one year before receipt of the observed evaluation of the subject property. Alternatively, the first technique, and certain still alternate preferred embodiments of the method of the present invention, may be optionally or additionally further constrained by limiting the comparison data considered within the method to ID/value couples having an associated market value determined no later than approximately six months before receipt of the observed evaluation of the subject property.

A second preferred embodiment of the method of the present inventions, or second technique, includes the use of an information technology system in executing certain or all aspects of the second technique. The second technique, and certain yet alternate preferred embodiments of the method of the present invention may optionally, alternatively or additionally include (1) storing a record of the observed evaluation of the subject property in an information technology system, (2) storing in the information technology system a photographic representation, such as a digital file of a photographic image or another suitable digital image known in the art, of the subject property in the information technology system, and/or (3) associating the photographic representation of the subject property with the record of the observed evaluation. The information technology system may exhibit or include the Internet, an extranet, an intra-net, wireless communications devices, cell phones, digitizing image scanning equipment, and other suitable information technology appliances, devices, networks, standards and data communication and storage techniques known in the art.

The second technique, and certain other alternate preferred embodiments of the method of the present invention may optionally, alternatively or additionally include (1) storing a record of the observed evaluation in an information technology system, (2) storing a GPS value of the subject property in the information technology system, and (3) associating the stored GPS value of the subject property with the record of the observed evaluation. Optionally, second technique may further comprise (1) storing a record of at least one evaluated alternate real estate property in an information technology system, (2) storing a photographic representation of the at least one evaluated alternate real estate property in the information technology system, and (3) associating the photographic representation of the at least one evaluated alternate real estate property with the record of the at least one evaluated alternate real estate property. Furthermore, the second technique, and certain yet alternate preferred embodiments of the method of the present invention may optionally, alternatively or additionally generating a consolidated database from at least two real estate property databases and providing the consolidated database to a data user, such as a customer, a mortgage company, a financial services firm, a government agency, or a real estate appraiser.

Certain alternate preferred embodiment of the method of the present invention include forming a record of the observed evaluation of the subject property at least partly upon an observation by the data gatherer of one or more aspects of the subject property selected from the group of real estate property aspects consisting of type of improvement, location influence, location proximity, site utility, building description, floor location, type of view, quality of view, style of structure, story count of structure, quality of structure, roof type, roof condition, exterior wall type, trim type, trim quality, condition of property, range of improvement of property relative to environs, vehicle parking feature, landscape quality, foundation value, ST TYPE value, PUBPRIV value, curb value, gutter value, sidewalk value, data gatherer comments, and red flag.

A third preferred embodiment of the method of the present invention, or third technique, includes providing a distributed information technology system useful for evaluating the market value of a subject real estate property located within a preselected geography. The third technique, and certain other preferred embodiments of the present invention may optionally, additionally or alternatively include (1) storing in digital media a collection of baseline records generated by a data gatherer, or a small number of identified data gatherers, of a plurality of alternate real estate properties located within a predefined geography, and/or (2) forming and storing in digital media a plurality, or at least one, comparison ID/value couple by containing a market value of at least one evaluated alternate real estate property within at least one of the baseline records.

A fourth preferred method of the present invention provides a computer-readable medium carrying one or more sequences of one or more instructions for buffering data, wherein the execution of the one or more sequences of the one or more instructions by one or more processors, causes the one or more processors to perform the steps of:

a. collecting in digital media baseline records generated by a data gatherer (and/or one or more sources of real estate data) of a plurality of alternate real estate properties located within the geography;

b. forming and storing in digital media at least one comparison ID/value couple by containing a market value of at least one evaluated alternate real estate property with at least one of the baseline records;

c. receiving an observed evaluation of the property from the data gatherer via the distributed technology system; and

d. providing the observed evaluation and at least one comparison ID/value couple to an appraiser for use in determining the market value of the property.

Other aspects of the present invention include an apparatus and a computer-readable medium configured to carry out the foregoing steps. The foregoing and other objects, features and advantages will be apparent from the following description of the preferred embodiment of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which: These, and further features of the invention, may be better understood with reference to the accompanying specification and drawings depicting the preferred embodiment, in which:

FIG. 1 is a schematic diagram of an identifying header and a related table of information describing the aspects of a real estate property.

FIG. 2 is a representation of a work process that compiles the information of one or more databases with the information of the table of FIG. 1.

FIG. 3 illustrates an information technology system comprising the Internet with which the work process of FIG. 2 may be executed.

FIG. 4 is a representation of an information technology system comprising a communications network employing wireless communications devices with which the work process of FIG. 2 may be executed.

### DETAILED DESCRIPTION OF A PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar result.

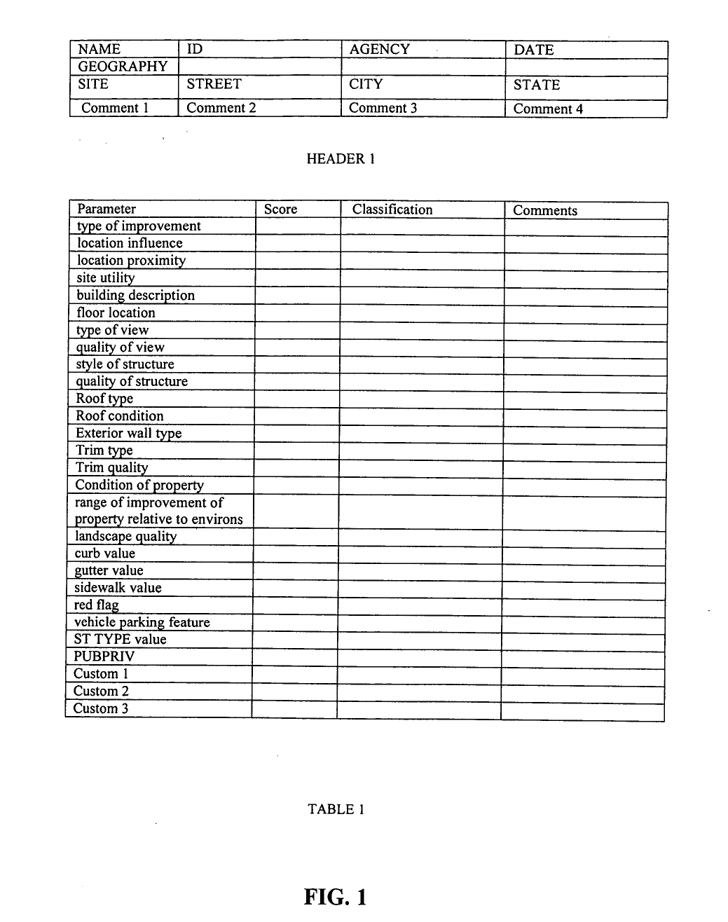

Referring now generally to the Figures and particularly to FIG. 1, FIG. 1 is a schematic diagram of an identifying header and a related table of information describing the aspects of a real estate property. The identification information in the Header 1 associates the data gatherer's name and an identification “ID”, such as an employee number or a certification or license number, with a particular subject property. The Table 1 lists a plurality of parameters that may affect the valuation of the subject property, to include, the parameters of and the of the location of the property in datafield A, the type of improvement, location influence, location proximity, site utility, building description, floor location, type of view, quality of view, style of structure, story count of structure, quality of structure, roof type, roof condition, exterior wall type, trim type, trim quality, condition of property, range of improvement of property relative to environs, vehicle parking feature, landscape quality, foundation value, ST TYPE value, PUBPRIV value, curb value, gutter value, sidewalk value, data gatherer comments, and a red flag condition.

The data gatherer uses the Table 1 to record (1) the existence of each parameter (when the parameter is observed or reported to be in existence), (2) a score relating to the relative degree of desirable quality of the parameter of the subject property, (3) any classification of the nature of the parameter, and (4) commentary regarding the parameter. As an example, under the parameter of “vehicle parking feature”, the data gather might observe that a driveway has a flat and level concrete surface and is sufficient to contain three vehicles. The data gatherer might therefore enter a high rating score into the Score Datafield, and note in the Classification Datafield that the driveway is of a three car parking class. In addition, the data gatherer might add in the Comments Datafield description information about the proximity of the driveway parking area to a house or garage of the subject property.

Table 1 and Header 1 may be stored and recorded in either hard copy media or electronic media, and may be transmitted as either hard copy or as electronic messages, or by means of suitable computer-readable media known in the art. The data gatherer might receive third-party information reported by other informants, such as an automated database, or an appraiser's records, prior to observing the subject property. The data gatherer might format, or receive a pre-formatted Table 1, with this third-party information, and observe the property to confirm the validity of the third party information, or to correct or enhance the third party information.

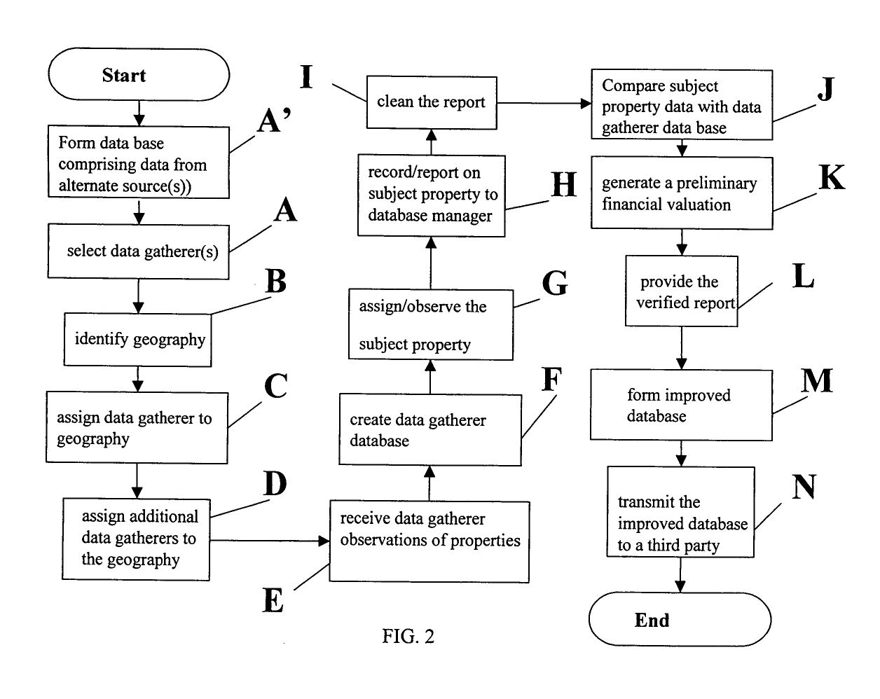

Referring now generally to the Figures and particularly to FIG. 2, FIG. 2 is a representation of a work process that compiles the information of one or more databases with the information of the table of FIG. 1. In an optional Step A′ a database is created that relates to descriptions and parameters associated with real estate properties, the database being populated with some or all data received from one or more sources other than the data gatherer(s) referred to in steps A trough F below. In Step A an individual data gatherer is selected and in Step B a particular geography is identified. The geography might be defined according to a neighborhood identity, or a postal code, such as a zip code issued by the United States Post Office, or by a unique set of real estate properties (“properties”) generated by a firm, agent or agency. The data gatherer is then assigned in Step C to observe and describe a number of properties within the geography. The properties selected may be at least partially chosen from a group of properties that includes properties sold within a substantially certain time frame, e.g., approximately six months or approximately one year, prior to the selection of a property for observation of the data gatherer. In optional Step D, a small group of data gatherers are identified and authorized to provide observations and reports concerning properties in the geography. In Step E, the data gatherer(s) records, and reports to a data manager, his, her, or their observations of each or selected property assigned for observation by means of Header 1 and Table 1 of FIG. 1, or other suitable real estate property data recording methods and means known in the art, and communicates these observations in reports to the data manager. A data gather database is then built up in Step F by recording a plurality of observations of a plurality of properties by the same data gatherer, or optionally as reported by a small group of data gatherers, as per Step D. The data gatherer database created in step F may optionally or alternatively comprise, or be comprised within, the database formed or provided in optional Step A′. recorded observations of each or many of the properties may then be coupled in Step F with the financial valuations of the properties by the data gatherer(s). By this method of a first preferred embodiment of the method of the present invention, a data history or database of the baseline observations of the individual data gatherer is established and related to reported financial values of the relevant properties. One or more ID/value couples may be formed in Step F, wherein each ID/value couple that includes (1) one or more previous observations made by the data gatherer of a first property, and (2) reported financial valuation of the first property. The reported financial valuation may be selected from the group including a market value, such as an actual sales price, a tax assessment value, or other financial valuations known in the art, such as a real estate appraisal. In Step F the data gather database is formalized for relating the history of the individual data gatherer's observations to the reported financial values. In certain alternate preferred embodiments of the method of the present invention, the database may be built with the reports and observations of a small group of data gatherer, e.g. approximately six individuals, rather than a single data gatherer. In Step G the data gatherer is assigned to observe the subject property and record his or her observations of the subject property. In Step H the data gatherer records and transmits his or her observations of the subject property to a data manager. The data manager in optional Step I may review and data clean the report generated by the data gatherer, the report optionally being substantially in the format of Header 1 and Table 1 of FIG. 1 and recorded and transmitted in either (or both) hard copy or electronic messaging or media. In the optional data cleaning of Step I the data manager may compare the recorded observations reported by the data gather with third-party information provided by alternate databases or information providing services. Some or all of this third-party information regarding the subject property may have additionally or alternatively been provided to the data gatherer before, during or after the observation of the subject property. GPS information or digital photographic imaging may optionally be attached or associated to a report of the observations by the data gatherer of the subject property in Steps E, F or I. Furthermore, the data gatherer may optionally have been provided third-party information regarding some or all of the properties of the subject property in the process of his or her generating and transmitting reports concerning the properties reported in Step E. In Step J the data manager compares the information provided by the data gatherer concerning the subject property with the history of observations concerning properties previously observed and reported on or by the data gatherer(s), and the data manager generates a verified report concerning the subject property in light of the observations concerning the subject property provided by the data gatherer(s) in Step H and the history of previous observations of the data gatherer as reported to the data manager in Step E. In optional Step K the data manager may generate a preliminary financial valuation of the subject property at least partially on the basis of the verified report of Step J, the database of Step E and information provided from third-party sources or databases. In Step L the data manager provides the verified report and optionally the preliminary financial valuation to a third party, such as a real estate appraiser, a real estate appraiser, a loan officer, an automated valuation service or other suitable financial, tax, or real estate professional, agency, service or webservice. In optional Step M the data manager may form an improved database by consolidating one or more third party databases with the verified report of the subject property and one or more of the baseline records of Step F and/or one or more of the ID/value couples of Step F. In Step N the database manager may transmit the improved database to a third party, such as a real estate appraiser, a real estate appraiser, a loan officer, an automated valuation service or other suitable financial, tax, or real estate professional, agency, service or webservice.

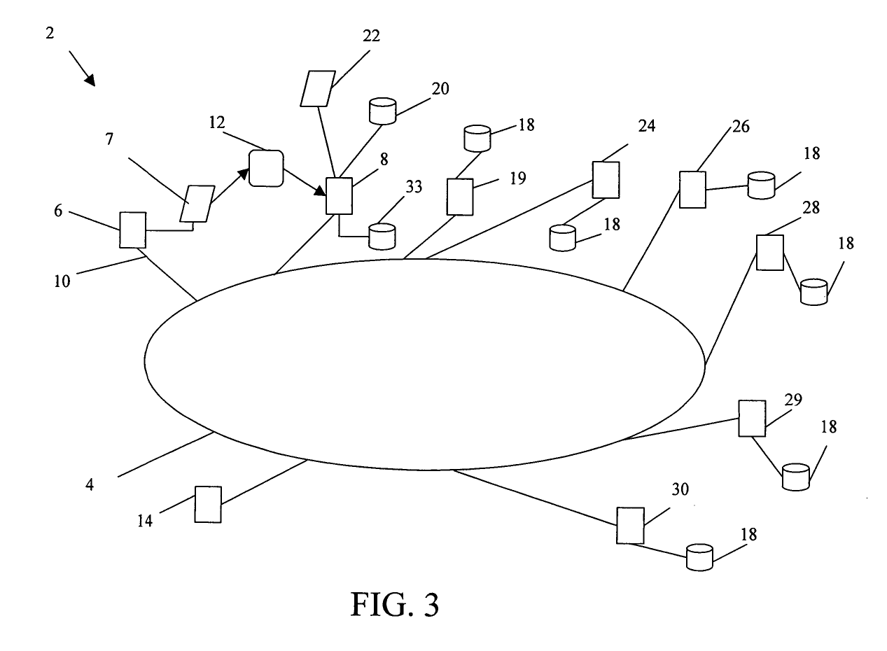

Referring now generally to the Figures and particularly to FIG. 3, FIG. 3 illustrates an information technology system 2 comprising the Internet 4 with which the work process of FIG. 2 may be executed. The data gatherer uses a personal digital assistant 6 (“PDA”), such as a PALM V personal digital assistant or a tablet personal computer to record an observation of the subject property or another property. The data gatherer then transmits the recorded observation as a report 7 to a data manager workstation 8 via an Internet connection 10 or a computer-readable medium 12, such as a floppy disk. The connection 10 may be or comprise a wireless connection or a hard wire connection, such as a telephone landline or a public utility cable. Additionally or alternatively, the personal digital assistant 6 may be or comprise a voice recorder or a telephone, and the data gather may submit the report 7 as one or more verbal records that are then translated by a transcriber 14 and therefrom provided to the data manager workstation 8. The transcriber 14 may be or comprise an automated software transcription system that accepts voice or voice recording input and translates the information content of the input into a digital record.

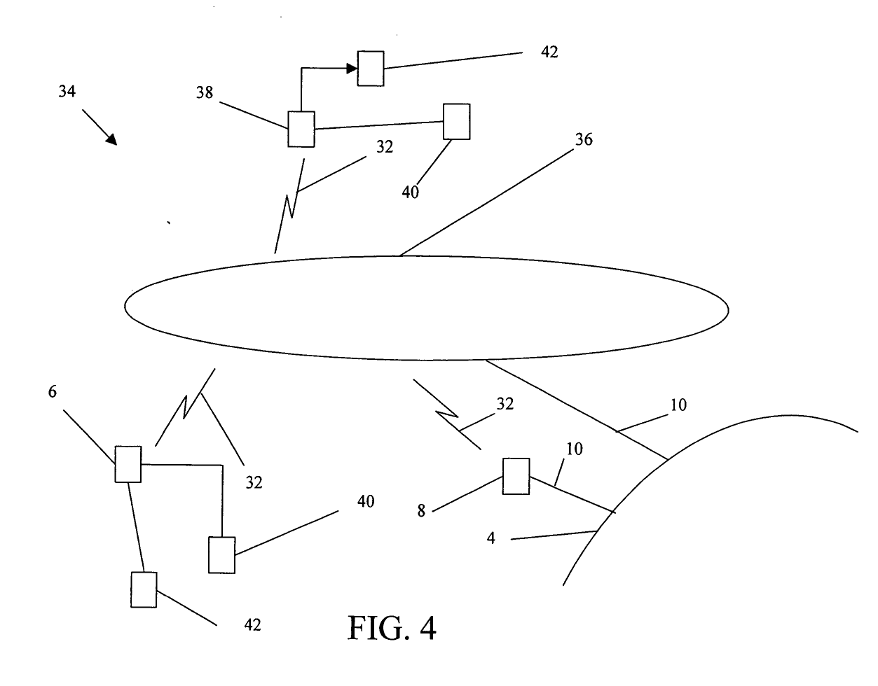

The data manager workstation 8, and the PDA 6, may each optionally have access, via the Internet 4 or by direct connection 16, to third-party databases 18 or database workstations 19 that contain information or databases associated with the subject property and/or other properties. A data manager or the data gatherer may clean, correct, validate, discard, and/or confirm the information provided by one or more third-party databases 18 by comparing this third party information the observations reported by the data gatherer. The data manager may then compare the report concerning the subject property with a data gatherer database (“DG database”) 20, where the DG database 20 includes a library of records of observations previously made by the data gatherer of properties located within the geography. One, many or all of the records of the DG database 20 may include financial valuations made of the property that the record describes. The data manager may thus massage the information provided in report 7 by the data gatherer to compensate for a pattern of subjective or idiosyncratic bias of the data gather made evident by an analysis of the data gatherers recorded observations contained in DG 20, and generate a verified report 22, where the verified report 22 is based upon the information contained in the report 7. The data manager may then (1) appraise the financial or market value of the subject property and generate an estimated market or financial value, and/or (2) provide report 7 and/or verified report 22 to an automated valuation service 24, a real estate appraiser workstation 26, a real estate appraiser appraiser workstation 28, a webservice workstation 29, or another party workstation 30. The reports 7 and 22 may be communicated or transmitted via wireless telephone links 32 (as per FIG. 4) or the information technology system 2. Additionally or optionally, the data manager may an improved database 33 by consolidating one or more third-party data 18 bases with the verified report of the subject property and one or more of the baseline records (as per Step F of FIG. 1) and/or one or more of the ID/value couples (also as per Step F of FIG. 1) of the DG database 20. The database manager may transmit the improved database 33 to a third party, such as an automated valuation service workstation 24, a real estate appraiser workstation 26, a real estate appraiser workstation 28, a webservice workstation 29, or another party workstation 30. A workstation as used herein is defined to comprise an electronic computational or communications device that may communicate data or signals via a computer-readable medium, the Internet or other suitable computer networks known in the art, or may be communicatively linked with at least one computer-readable medium.

Referring now generally to the Figures and particularly to FIG. 4, FIG. 4 is a representation of an information technology system 34 comprising a communications network 36 employing wireless communications devices 38 with which the work process of FIG. 2 or other alternate preferred embodiments of the present invention may be executed. The wireless communications device 38, and the PDA 6, may optionally include or be communicatively linked to a digital photography module 40, whereby digital image data concerning the subject property may be recorded by the digital photography module 40 and provided to the data manager workstation 8 via the information technology system 34, computer-readable media 12, and or the network 2. A GPS module 42, may optionally include or be communicatively linked wireless communications device 38, and the PDA 6, whereby GPS data concerning the subject property may be recorded by the GPS module 42 and provided to the data manager workstation 8 via a wireless communications link 32, the information technology system 2, computer-readable media 12, and or the information technology system 2.

Referring now generally to the Figures, the first preferred embodiment of the method of the present invention, or first method, provides a technique for evaluating the market value of a subject real estate property, wherein the subject real estate property (“subject property”) is located within a geography. The first method includes certain optional steps, to include:

f. collecting baseline records generated by the data gatherer, or a small number of identified individual data gatherers, of a plurality of alternate real estate properties located within the geography;

g. forming the DG database 20 a plurality of ID/value couples, or at least one comparison ID/value couple, by associating a market value of at least one evaluated alternate real estate property with at least one of the baseline records, where a financial valuation of each alternate property, such as a sales price and/or another suitable financial metric known in the art is paired with a baseline record, each baseline record including a description of the relevant property;

h. receipt of an observed evaluation of the subject property by a user of the data from the data gatherer, or one of the plurality of identified data gatherers; and

i. assessing, appraising or estimating the market value of the subject property by comparison of the observed evaluation of the subject property with the plurality of ID/value couples, or at least one comparison ID/value couple, whereby the judgement of the same data gatherer, or the small group of data gathers, at least partially determines the informational content of at least one comparison ID/value couple and the observed evaluation of the subject property.

The financial or market valuation of the subject property, and one or more comparison ID/value couples, may be provided to a user of data, such as a government agency, a mortgage company or another suitable financial services venture known in the art, to include an automated valuation service 24. The financial valuation associated with an alternate real estate property may optionally be provided by or sourced from the automated real estate valuation service 24. In addition, the first technique, and certain alternate preferred embodiments of the method of the present invention, may be optionally directed to limit the comparison data considered within the method to ID/value couples having an associated market value determined no later than approximately one year before receipt of the observed evaluation of the subject property. Alternatively, the first technique, and certain still alternate preferred embodiments of the method of the present invention, may be optionally or additionally further constrained by limiting the comparison data considered within the method to ID/value couples having an associated market value determined no later than approximately six months before receipt of the observed evaluation of the subject property.

A second preferred embodiment of the method of the present inventions, or second technique, includes the use of an information technology system 2 configured to execute certain or all aspects of the second technique. The second technique, and certain yet alternate preferred embodiments of the method of the present invention may optionally, alternatively or additionally include (1) storing a record of the observed evaluation of the subject property in the information technology system 2, (2) storing in the information technology system 2 a photographic representation, such as a digital file of a photographic image or another suitable digital image known in the art, of the subject property in the information technology system 2, and/or (3) associating the photographic representation of the subject property with the record of the observed evaluation. The information technology system 2 may exhibit or include the Internet, an extranet, an intra-net, wireless communications devices, cell phones, digitizing image scanning equipment, and other suitable information technology appliances, devices, networks, standards and data communication and storage techniques known in the art.

The second technique, and certain other alternate preferred embodiments of the method of the present invention may optionally, alternatively or additionally include (1) storing a record of the observed evaluation in the information technology system 2, (2) storing a GPS value of the subject property in the information technology system 2, and (3) associating the stored GPS value of the subject property with the record of the observed evaluation. Optionally, second technique may further comprise (1) storing a record of at least one evaluated alternate real estate property in the information technology system 2, (2) storing a photographic representation of the at least one evaluated alternate real estate property in the information technology system, and (3) associating the photographic representation of the at least one evaluated alternate real estate property with the record of the at least one evaluated alternate real estate property. Furthermore, the second technique, and certain yet alternate preferred embodiments of the method of the present invention may optionally, alternatively or additionally generating a consolidated or improved database 33 from at least two real estate property databases 18 and providing the consolidated database 33 to a data user, and/or (2) provide report 7 and/or verified report 22 to an automated valuation service 24, a real estate appraiser workstation 26, a real estate appraiser 28, webservice 29, or another party 30.

A third preferred embodiment of the method of the present invention, or third technique, includes providing the distributed information technology system 2 configured to be useful for evaluating the market value of a subject real estate property located within a preselected geography. The third technique, and certain other preferred embodiments of the present invention may optionally, additionally or alternatively include (1) storing in digital media 12 a collection of baseline records generated by a data gatherer, or a small number of identified data gatherers, of a plurality of alternate real estate properties located within a predefined geography, and/or (2) forming and storing in digital media 12 a plurality, or at least one, comparison ID/value couple by containing a market value of at least one evaluated alternate real estate property within at least one of the baseline records.

A fourth preferred method of the present invention provides a computer-readable medium 12 carrying one or more sequences of one or more instructions for buffering data, wherein the execution of the one or more sequences of the one or more instructions by one or more processors, causes the one or more processors to perform the steps of:

e. collecting in digital media baseline records generated by a data gatherer of a plurality of alternate real estate properties located within the geography;

f. forming and storing in digital media 12 at least one comparison ID/value couple by containing a market value of at least one evaluated alternate real estate property with at least one of the baseline records;

g. receiving an observed evaluation of the property from the data gatherer via the distributed technology system 2; and

h. providing the observed evaluation and at least one comparison ID/value couple to an appraiser for use in determining the market value of the property.

The term “computer-readable medium” as used herein refers to any suitable medium known in the art that participates in providing instructions to the network 2 for execution. Such a medium may take many forms, including but not limited to, non-volatile media, volatile media, and transmission media. Non-volatile media includes, for example, optical or magnetic disks, such as storage device 10. Volatile media includes dynamic memory. Transmission media includes coaxial cables, copper wire and fiber optics. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to the network 2 for execution. For example, the instructions may initially be carried on a magnetic disk of a remote computer. The remote computer can load the instructions into its dynamic memory and send the instructions over a telephone line using a modem. A modem local to or communicatively linked with the network 2 can receive the data on the telephone line and use an infra-red transmitter to convert the data to an infra-red signal. An infra-red detector can receive the data carried in the infra-red signal and appropriate circuitry can provide the data to the network 2.

Those skilled in the art will appreciate that various adaptations and modifications of the just-described preferred embodiments can be configured without departing from the scope and spirit of the invention. Other suitable evaluation techniques and methods known in the art can be applied in numerous specific modalities by one skilled in the art and in light of the description of the present invention described herein. Therefore, it is to be understood that the invention may be practiced other than as specifically described herein. The above description is intended to be illustrative, and not restrictive. Many other embodiments will be apparent to those of skill in the art upon reviewing the above description. The scope of the invention should, therefore, be determined with reference to the knowledge of one skilled in the art and in light of the disclosures presented above.

1. A method for evaluating the market value of a subject real estate property, the subject real estate property (“subject property”) located within a geography, the method comprising:
j. collecting baseline records generated by a data gatherer of a plurality of alternate real estate properties located within the geography;
k. forming at least one comparison ID/value couple by associating a market value of at least one evaluated alternate real estate property with at least one of the baseline records;
l. receiving an observed evaluation of the subject property from the data gatherer; and
m. assessing the market value of the subject property by comparison of the observed evaluation of the subject property with at least one comparison ID/value couple, whereby the judgement of the same data gatherer at least partially determines the informational content of at least one comparison ID/value couple and the observed evaluation of the subject property.

2. The method of claim 1, wherein the method further comprises:
n. a generation by the data gatherer of a plurality of comparison ID/value couples; and
o. assessing the market value of the property by a comparison of the observed evaluation of the subject property with more than one of the comparison ID/value couples.

3. The method of claim 1, wherein the method further comprises limiting the comparison ID/value couples used by the method to comparison ID/value couples having an associated market value determined no later than approximately one year before receipt of the observed evaluation of the subject property.

4. The method of claim 1, wherein the method further comprises limiting the comparison ID/value couples used by the method to comparison ID/value couples having an associated market value determined no later than six months before receipt of the observed evaluation of the subject property.

5. The method of claim 1, wherein the method further comprises:
e. storing a record of the observed evaluation in an information technology system;
f. storing a photographic representation of the subject property in the information technology system; and
g. associating the photographic representation of the subject property with the record of the observed evaluation.

6. The method of claim 1, wherein the method further comprises:
e. storing a record of the observed evaluation in an information technology system;
f. storing a GPS value of the subject property in the information technology system; and
f. associating the stored GPS value of the subject property with the record of the observed evaluation.

7. The method of claim 1, wherein the method further comprises:
e. storing a record of at least one evaluated alternate real estate property in an information technology system;
f. storing a photographic representation of the at least one evaluated alternate real estate property in the information technology system; and
g. associating the photographic representation of the at least one evaluated alternate real estate property with the record of the at least one evaluated alternate real estate property.

8. The method of claim 1, wherein at least one market value of a comparison ID/value couple is a sales price.

9. The method of claim 1, wherein the method further comprises providing the market value of the property to an automated valuation service.

10. The method of claim 2, wherein the method further comprises providing the market value of the property and the plurality of comparison ID/value couples to an automated valuation service.

11. The method of claim 2, wherein a market value of at least one of the comparison ID/value couples is provided by an automated valuation service.

12. The method of claim 1, wherein the method further comprises forming a record of the observed evaluation of the subject property at least partly upon an observation by the data gatherer of an aspect of the property selected from the group of aspects consisting of type of improvement, location influence, location proximity, site utility, building description, floor location, type of view, quality of view, style of structure, story count of structure, quality of structure, roof type, roof condition, exterior wall type, trim type, trim quality, condition of property, range of improvement of property relative to environs, vehicle parking feature, landscape quality, foundation value, ST TYPE value, PUBPRIV value, curb value, gutter value, sidewalk value, data gatherer comments, and red flag.

13. In a distributed information technology system, a method for evaluating the market value of a real estate property, the real estate property (“property”) located within a geography, the method comprising:
a. collecting in digital media baseline records generated by a data gatherer of a plurality of alternate real estate properties located within the geography; and
b. forming and storing in digital media at least one comparison ID/value couple by containing a market value of at least one evaluated alternate real estate property within at least one of the baseline records.

14. The method of claim 13, wherein the method further comprises:
c. receiving a record of an observed evaluation of the subject property from the data gatherer via the distributed technology system; and
d. providing the record of the observed evaluation of the subject property and at least one comparison ID/value couple to an appraiser for use in determining the market value of the property.

15. The method of claim 14, wherein the distributed information technology system comprises a wireless communications device, and the method further comprises the data gatherer providing the observed evaluation of the subject property to the appraiser via the wireless communications device.

16. The method of claim 14, wherein the method further comprises providing a photographic record of the property to a customer.

17. The method of claim 16, wherein the method further comprises providing at least one photographic record of at least one alternate real estate property to the customer.

18. The method of claim 14, wherein the method further comprises generating a consolidated database from at least two real estate property databases and providing the consolidated database to the customer.

19. The method of claim 14, wherein the method further comprises providing the market value of the property to an automated valuation service.

20. The method of claim 14, wherein the method further comprises a basis of the observed evaluation at least partly upon an observation by the data gatherer of an aspect of the property selected from the group of aspects consisting of type of improvement, location influence, location proximity, site utility, building description, floor location, type of view, quality of view, style of structure, story count of structure, quality of structure, roof type, roof condition, exterior wall type, trim type, trim quality, condition of property, range of improvement of property relative to environs, vehicle parking feature, landscape quality, foundation value, ST TYPE value, PUBPRIV value, curb value, gutter value, sidewalk value, data gatherer comments, and red flag.

21. A computer-readable medium carrying one or more sequences of one or more instructions for buffering data, wherein the execution of the one or more sequences of the one or more instructions by one or more processors, causes the one or more processors to perform the steps of:
i. collecting in digital media baseline records generated by a data gatherer of a plurality of alternate real estate properties located within the geography;
j. forming and storing in digital media at least one comparison ID/value couple by containing a market value of at least one evaluated alternate real estate property with at least one of the baseline records;
k. receiving an observed evaluation of the property from the data gatherer via the distributed technology system; and
l. providing the observed evaluation and at least one comparison ID/value couple to an appraiser for use in determining the market value of the property.

22. A method for formatting a database relating to real estate values within an information technology system, the method comprising:
a. identifying a plurality of real estate properties, or comps;
b. collecting comp data related to at least one of the comp properties by a data gatherer;
c. review and edit of at least some of the comp data by the data gatherer; and
d. populating a database with the comp data after review and edit of the comp data by the data gatherer; and
e. providing the database to a third party, whereby the database substantially comprises data reviewed and edited by the data gatherer.

23. The method of claim 22, wherein the data gatherer is an individual or a group of less than six individuals.

24. The method of claim 22, wherein the third party is selected from the group consisting of a real estate appraiser, a tax assessor, a loan officer, a real estate professional, a financial services professional, and information technology system, a computer-readable medium, an automated valuation service, a webservice and a data gatherer.

25. The method of claim 22, wherein the method further comprises associating a financial value with at least one comp.

26. The method of claim 25, werein the financial value is selected from the group consisting of a sales price, an assessed value, an appraised value, an estimated value, a recorded value, and or a sales price.
